(19) United States
(12) Patent Application Publication
(10) Pub. No.: US 2022/0042892 A1
(43) Pub. Date: Feb. 10, 2022

(54) Method and system for obtaining properties using indentation imprint

(71) Applicant: SOGANG UNIVERSITY RESEARCH & BUSINESS DEVELOPMENT FOUNDATION, Seoul (KR)

(72) Inventors: Hyung Yil Lee, Goyang-si (KR); Ye Won Hwang, Seoul (KR); Nak Soo Kim, Goyang-si (KR); Karuppasamy Pandian Marimuthu, Seoul (KR)

(21) Appl. No.: 17/394,703

(22) Filed: Aug. 5, 2021

(30) Foreign Application Priority Data
Aug. 10, 2020 (KR) 10-2020-0100111

(51) Int. Cl. G01N 3/30; G01N 3/06

(52) U.S. Cl. CPC G01N 3/30; G01N 3/068

(57) ABSTRACT

Disclosed is a method for obtaining properties using an indentation. The method includes an initial value calculating step, a reference value calculating step, a pre-set value setting step and a checking step. So the method obtains properties only using an indentation without additional experiments

### TECHNICAL FIELD

The present application claims the benefit of priority to Korea Patent Application No. 10-2020-0100111, titled “MEASURING METHOD USING THE SURFACE DISPLACEMENT AND MEASURING SYSTEM USING THE SAME METHOD”, filed with the Korea National Intellectual Property Administration on Aug. 10, 2020, the entire disclosure of which is incorporated herein by reference.

The present disclosure relates to a method and system for obtaining properties using an indentation imprint. More particularly, the present disclosure relates to a method and system for obtaining properties only using an indentation imprint without additional experiments using a displacement of a horizontal distance.

### BACKGROUND

Reliability of a product is very important. Therefore, a reliability test performed after finishing the product is one of the very important post-processes in industrial fields. A tensile test is generally used as a method of evaluating material properties of the product. However, rigid standard specimens and product damage are required in the tensile test. In addition, microscale and nanoscale local properties are difficult to be obtained in the tensile test, as such, there is a limit to its use in the industrial fields.

Therefore, in order to test the reliability of the product, there is a rising interest in an indentation test method having an advantage of obtaining microscale and nanoscale local properties without damaging the product. In the indentation test method, properties are obtained using a method of using indentation load-displacement curves obtained by pressurizing a surface of the product with different-shaped indenters or using traces of a pressure (indentation) formed at the time of removing the indenters.

However, the indentation test method has disadvantages as follows.

Firstly, in the method of using indentation load-displacement curves, inaccurate results occur due to an external environmental factor, such that additional experiments should be performed. It is predicted that the inaccurate results occur due to problems with initial contact or equipment itself. In order to resolve the problems, currently, additional experiments are accompanied by the indentation test method.

Secondly, a method of using an indentation is utilized. In the method of using an indentation, it is possible to evaluate a material using the indentation obtained in a one-time test. However, a problem in similar properties occurs in the method of using an indentation, and in order to solve the problem, multiple tests are required. In addition, since available information on the indentation is currently limited to use only vertical displacement information, it is difficult to evaluate the problem in similar properties by a one-time test.

The indentation test method has such an advantage, but has disadvantages such as inaccurate results, utilization of separate equipment, and requirement of additional experiments. Therefore, the indentation test method having the disadvantages is difficult to be applied in the industrial fields.

### SUMMARY

According to an embodiment of the present disclosure, a method for obtaining properties using an indentation includes: an initial value calculating step of calculating a vertical distance value from the indentation; a reference value calculating step of calculating, from a preset horizontal distance value, a reference horizontal displacement field value, which is a horizontal displacement field value corresponding to the calculated vertical distance value from the indentation, using a relationship between a pre-obtained vertical distance value and the reference horizontal displacement field value; a pre-set value setting step of setting an arbitrary assumed value of the properties; and a checking step of checking whether the properties are set as the pre-set value by comparing the horizontal displacement field value obtained from the preset horizontal distance value with the reference horizontal displacement field value and checking whether the horizontal displacement field value and the reference horizontal displacement field value are within an error range, using a relationship between horizontal displacement field values according to a pre-obtained horizontal distance value for each property.

In the reference value calculating step, the reference horizontal displacement field value and a reference horizontal distance value, which is a horizontal distance value corresponding to the reference horizontal displacement field value, may be calculated using a relationship between the horizontal displacement field values according to a pre-obtained horizontal distance value for each friction coefficient, and the pre-set horizontal distance value may be set to be within a range of not being less than the reference horizontal distance value.

In the initial value calculating step, a maximum vertical distance value measured according to plastic deform of the material may be calculated, and in the reference value calculating step, a vertical indentation variable may be calculated by dividing the maximum vertical distance value by the vertical distance value.

In the pre-set value setting step, the pre-set value may include a strain hardening exponent value set arbitrary and an arbitrary yield strength value, and in the checking step, a relationship between the strain hardening exponent value of materials having different yield strengths and indentation variables calculated by dividing the maximum vertical value by the vertical distance value may be pre-obtained, and whether an indentation variable calculated according to the pre-set value and the vertical indentation variable are within the preset error range may be checked by comparing the indentation variable and the vertical indentation variable.

In the checking step, the pre-set value may be reset when any one of a result of comparing the calculated horizontal displacement field value with the reference horizontal displacement field value in the reference value calculating step and a result of comparing the indentation variable and the vertical indentation variable are out of the error range.

According to embodiments of the present disclosure, a system for obtaining properties includes: a variable calculating unit configured to calculate a vertical distance value from indentation data of the material; a reference value calculating unit configured to receive the vertical distance value and calculate a reference horizontal displacement field value corresponding to the vertical distance value using a relationship between a pre-stored vertical distance value and the reference horizontal displacement field value; and a checking unit configured to receive an arbitrary pre-set value of the properties, output a horizontal displacement field value corresponding to the pre-set value using a relationship between horizontal displacement field values according to a pre-stored horizontal distance value for each property, and check whether the output horizontal displacement field value and the reference displacement field value are within an error range by comparing the output horizontal displacement field value and the reference displacement field value.

The reference value calculating unit may calculate a reference horizontal distance value corresponding to the reference horizontal displacement field value using pre-stored data about a relationship between the horizontal displacement field values according to the horizontal distance value for each friction coefficient, and the preset horizontal distance value may be at least not less than the reference horizontal distance value.

The variable calculating unit may calculate a maximum vertical distance value measured according to plastic deform and pre-calculated through the indentation data, and the reference value calculating unit may calculate a vertical indentation variable by dividing the maximum vertical distance value by the vertical distance value.

A strain hardening exponent of materials having different yield strengths and a relationship between indentation variables obtained by dividing the maximum vertical distance value by the vertical distance value may be pre-stored, and when the strain hardening exponent value is received as the pre-set value, the checking unit may calculate a constant value corresponding to the received strain hardening exponent value and compare the constant value and a reference constant value to check whether the constant value and the reference constant value are within the error range.

According to an embodiment, the present disclosure may obtain the properties of the product by utilizing a displacement (displacement field) of the horizontal distance of the indentation, and accurately obtain the properties of the product in one-time experiment without expensive separate equipment.

### BRIEF DESCRIPTION OF THE DRAWINGS

FIG. 1 is a flowchart of a method for obtaining properties using an indentation according to an embodiment.

FIG. 2 is a picture obtained by capturing an image of an indentation using a surface profiler and a digital image correlation (DIC) technique according to an embodiment.

FIG. 3A illustrates a vertical distance value according to a horizontal distance and a maximum vertical distance value according to an embodiment, and FIG. 3B illustrates a horizontal displacement field value according to a horizontal distance according to an embodiment.

FIG. 4 illustrates a configuration of a system for obtaining properties according to an embodiment.

FIG. 5 illustrates, with tensile stress-strain curves, the obtaining properties in STS 304 using a tensile test, an existing indentation test method, and a method and system for obtaining properties using an indentation according to an embodiment of the present invention.

### DETAILED DESCRIPTION

Hereinafter, an embodiment of the present disclosure will be described with reference to accompanying drawings. However, it is not intended to limit the scope of the present disclosure.

It should be noted that the same elements will be designated by the same reference numerals although they are shown in different drawings in adding the reference numerals to elements of each drawing. Further, in the following description of the present disclosure, a detailed description of known functions and configurations incorporated herein will be omitted when it may make the subject matter of the present disclosure rather unclear.

Further, the sizes and shapes of the components shown in the drawings may be exaggerated for clarity and convenience. Further, terms specifically defined by taking into consideration the configuration and operation of the present invention are merely for illustrating the embodiment of the present disclosure and do not limit the scope of the present disclosure.

Further, in the present specification, each of the reference numerals and terms is defined as follows.

D: Diameter of indenter

σ: True stress

σ₀: Yield stress

K: Strength coefficient

E: Modulus of elasticity

εₜ: True strain

n: Strain hardening exponent

uᵣ: Horizontal displacement field value

rᵣₑₚ: Reference horizontal distance value

Uᵣₑₚ: Reference horizontal displacement field value

hₚ: Vertical distance value

c²: Indentation variable

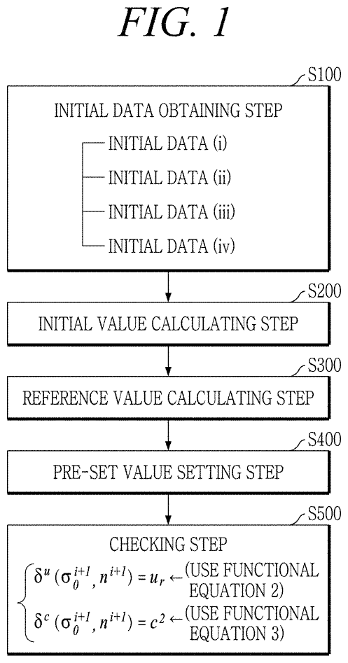

FIG. 1 is a flowchart of a method for obtaining properties using an indentation according to an embodiment.

The method for obtaining properties using an indentation according to an embodiment of the present disclosure may include an initial data obtaining step S100, an initial value calculating step S200, a reference value calculating step S300, a pre-set value setting step S400, and a checking step S500.

An initial data collecting step is a step of collecting data that is the basis for obtaining properties.

The initial data collecting step is a step of collecting data about a correlation between a material and an indentation. For example, the data is based on a Hollomon model.

$$Equation related to Hollomon model$$

$$σ = \{ \begin{matrix}E ɛ \text{?} & ( σ \leq {σ}_{o} ) \\ K ɛ \text{?} & ( σ \geq {σ}_{o} , 1 < n \leq ∞ )\end{matrix} \\ \text{?} \text{indicates text missing or illegible when filed}$$

That is, in the initial data collecting step, initial data may be collected by performing various indentation tests on the material having various yield strengths and strain hardening exponents. The initial data here may include a numerical analysis of a horizontal displacement field value. The numerical analysis of the horizontal displacement field value here means an analysis of a relationship between properties of the object and a horizontal displacement field value.

Through the numerical analysis, when a specific indentation is applied to the material having various yield strengths and strain hardening exponents, the initial data may set a relationship between a vertical distance value, a maximum vertical distance value, a horizontal displacement field value at a specific distance value, and the like, and initial data about the following relationship may be obtained.

Hereinafter, the initial data obtained through a specific embodiment will be described for convenience of understanding. (For reference, symbols composed of a denominator and a numerator will be described later using a numerator term. In addition, the following data were collected through a finite element analysis.)

The present inventors have established and examined a relationship between horizontal displacement field values according to a horizontal distance value with different strain hardening exponent values.

For example, a friction coefficient value is set to 0.1, and a modulus of elasticity value is set to 200 GPa, and a yield strength value is set to 200 MPa. In addition, the strain hardening exponent values are set to 5, 10, 15, and 20.

In this case, it may be confirmed that the horizontal displacement field value gradually increases as the horizontal distance value increases and decreases after passing through a specific horizontal distance value, and thus converges to 0.

The present inventors have confirmed whether this tendency is similar to a case where the set value is different. For example, a friction coefficient value, a modulus of elasticity value, and a yield strength value are set to 0.1, 200 GPa, and 800 GPa, respectively. In addition, the strain hardening exponent values are set to 5, 10, 15, and 20.

In this case, the horizontal displacement field value is less than that having a yield strength value of less than 200 MPa, and when the horizontal displacement field value decreases, the horizontal distance value also decreases. However, it may be confirmed that the tendency of the horizontal displacement field value to increase to a specific horizontal distance value and decrease when passing through a specific horizontal distance value is similar to the case where the set value is different.

The present inventors have checked characteristics as described above and a relationship of the horizontal displacement field values with the horizontal distance value for each friction coefficient.

For example, a yield strength value, a modulus of elasticity value, and a strain hardening exponent value are set to 400 MPa, 200 GPa, and 10, respectively. In addition, the friction coefficient values are set to 0, 0.1, 0.2, and 0.3. Referring to the values, it may be confirmed that the relationship between the horizontal distance value and the horizontal displacement field value also has tendency.

That is, a tendency of the horizontal displacement field value to increase as the horizontal distance value increases and gradually decrease when passing through a specific horizontal distance value may be confirmed.

A significant result may be obtained in such a relationship between the horizontal distance value and the horizontal displacement field value for each friction coefficient. The horizontal displacement field value is hardly affected by the friction coefficient value at the horizontal distance value or greater which is set immediately.

Since it is very difficult to measure the friction coefficient value in a material (object), if a point which is not affected by the friction coefficient value may be known, an analysis is performed after the point, and the friction coefficient may not be considered. The same tendency applies to the horizontal displacement field value with different yield strength values, modulus of elasticity, and strain hardening exponent value.

The present inventors have confirmed the above data, set the horizontal distance value having an insignificant influence on the friction coefficient value to a reference horizontal distance value, and set the horizontal displacement field value to a reference horizontal displacement field value.

Also, the present inventors have examined a relationship between the vertical distance value and a reference horizontal displacement field value for each yield strength and strain hardening exponent.

Although not illustrated in Graph 4 here, a strain hardening exponent is also considered.

For example, as confirmed from Graph 4, there are six white circular dots at a yield strength of 200 MPa, which shows that the strain hardening exponents are 5, 7, 13, 15, and 20 (strain hardening exponents=5, 7, 13, 15, 20) when the yield strength is 200 MPa. When the strain hardening exponent is small at the same yield strength, the vertical distance value decreases. Since this tendency is illustrated in Graph 4, the strain hardening exponent is also considered.

For example, the yield strength values are set to 200 MPa, 250 MPa, 400 MPa, 600 MPa, and 800 MPa. As a result of a regression analysis of the values, there is a slight difference according to the yield strength, but it is found that the reference horizontal displacement field value has a specific tendency according to the vertical distance value. In addition, it is found that when an equation is determined through the regression analysis, the equation is expressed by a first functional equation as follows.

$$\text{-} First functional equation$$

$$\text{?} / D = \text{?} ( {h}_{p} / D ) = 6.31 \times [ exp ( 8.55 ( {h}_{p} / D ) ) - 1 ] \times {10}^{- 3}$$

$$\text{?} \text{indicates text missing or illegible when filed}$$

The present inventors have devised an algorithm of the following contents with the above initial data.

(1) If the vertical distance value is known through the relationship between the vertical distance value and the reference horizontal displacement field value for each yield strength and strain hardening exponent, the reference horizontal displacement field value may be obtained.

(2) If the reference horizontal displacement field value is known, the reference horizontal distance value may be known using the relationship between the horizontal displacement field values according to the horizontal distance value for each friction coefficient (this is because the reference horizontal distance value corresponds to the reference horizontal displacement value one to one).

(3) If the reference horizontal distance value is known, a range of the horizontal distance value for analysis may be set using the relationship between the horizontal displacement field values according to the horizontal distance value for each friction coefficient. This is because the horizontal displacement field value is greatly changed depending on the friction coefficient value at a horizontal distance value immediately before the reference horizontal distance value, and thereafter, the horizontal displacement field value is hardly affected by the friction coefficient value. However, when the horizontal displacement field value is too small, the significant data may not be measured. Thus, a portion where the significant data may not be measured is discarded.

Based on the above algorithm, it is preferable to set “reference horizontal distance value<horizontal distance value<2*reference horizontal distance value” which is a range of the analysis.

In addition, regression analysis is performed on the reference horizontal distance value and the 2*reference horizontal distance value from the reference horizontal distance value by using the relationship between the horizontal displacement field values according to the above horizontal distance value, and as a result, the following Functional Equation 2 may be obtained.

$$Functional Equation 2$$

$$\begin{matrix}u \text{?} ( r / D , {σ}_{o} / E , n ) = f \text{?} ( r / D , {σ}_{o} / E , n ) \\ A \text{?} + exp [ {A}_{1} - {A}_{2} ( r / D ) ]\end{matrix}$$

$${A}_{i} = {F}_{i}^{n} ( {σ}_{o} / E , n ) = β \text{?} {{n}^{- j} [ ( {σ}_{o} / E ) \times {10}^{3} ]}^{k}$$

$$for i = 0 , 1 , 2 ; j = 0 , 1 , 2 ; k = 0 , 1 , 2 , 3$$

$$\text{?} \text{indicates text missing or illegible when filed}$$

As such, the present inventors may narrow the range of the analysis using the horizontal distance value and the horizontal displacement field value from a large amount of property data in various materials.

If a tendency between different characteristics for each yield strength value and strain hardening exponent, which are properties of an unknown material, may be known, the yield strength value and the strain hardening exponent value may be confirmed.

As various results from the finite element analysis, the present inventors have found that the relationship between the horizontal distance value and the horizontal displacement field value for each strain hardening exponent has a constant tendency.

As a result of confirming the relationship between the horizontal displacement field values according to the horizontal distance value for each strain hardening exponent, it is confirmed that as the horizontal distance value increases, the horizontal displacement field value decreases. As the strain hardening exponent value increases, the horizontal displacement field value may increase at a specific horizontal distance value or less, but gradually decreases at a specific horizontal distance value or greater.

In addition, the present inventors have confirmed that the relationship between the strain hardening exponent and an indentation variable for each yield strength also has a tendency.

More accurately, the tendency between an inverse number of the strain hardening exponent value and the indentation variable may be confirmed. The indentation variable is a value obtained by dividing the maximum vertical distance by the vertical distance.

c²=hₚₛ/hₚ

As can be seen from x in Graph 6, it may be confirmed that there is a tendency that as the strain hardening exponent decreases (inverse number of the strain hardening exponent increases), the indentation variable decreases, and it may be found that as the yield strength value is small, the indentation variable is large.

Performing the regression analysis, the following Functional Equation 3 may be determined.

$$\text{-Functional Equation 3}$$

$${c}^{2} = \text{?} ( {σ}_{o} / E . n ) = {α}_{ij} {{n}^{- 1} [ ( {σ}_{o} / E ) \times {10}^{3} ]}^{f} , for i = 0 , 1 , 2 : j = 0 , 1 , 2$$

$$\text{?} \text{indicates text missing or illegible when filed}$$

In short, through the initial data obtaining step S100, initial data (i) to (iv) may be obtained:

Initial data (i): a relationship between the horizontal displacement field values according to the horizontal distance value for each friction coefficient,

Initial data (ii): a relationship between the vertical distance value and the reference horizontal displacement field value for each yield strength and strain hardening exponent,

Initial data (iii): a relationship between the horizontal distance value and the horizontal displacement field value for each strain hardening exponent and yield strength, and

Initial data (iv): a relationship between the strain hardening exponent value and the indentation variable for each yield strength and strain hardening exponent.

The initial value calculating step S200 is a step of calculating the vertical distance value by analyzing an indentation.

(Hereinafter, regarding properties of the material, it is assumed that the yield strength is 400 MPa and the strain hardening exponent is 10 as in Graph 3, for convenience of description.)

In addition, in the initial value calculating step S200, the maximum vertical distance value may be calculated by analyzing the indentation.

In the present disclosure, the vertical distance value of a surface of the material after indentation may be obtained using a surface profiler.

Further, in the present disclosure, the maximum vertical distance value may be calculated. The maximum vertical distance value may refer to a distance from the maximum indentation depth of an indentation center in which the material is plastically deformed due to the indentation to pile-up/sink-in.

Further, in the present disclosure, a shape of the surface of the material before and after indentation is analyzed using a digital image correlation (DIC) technique. The digital image correlation technique is a technique capable of forming an irregular pattern on the material and analyzing a shape of the pattern before and after indentation to analyze an indentation.

A result obtained by analyzing the surface by the method according to an embodiment is as follows.

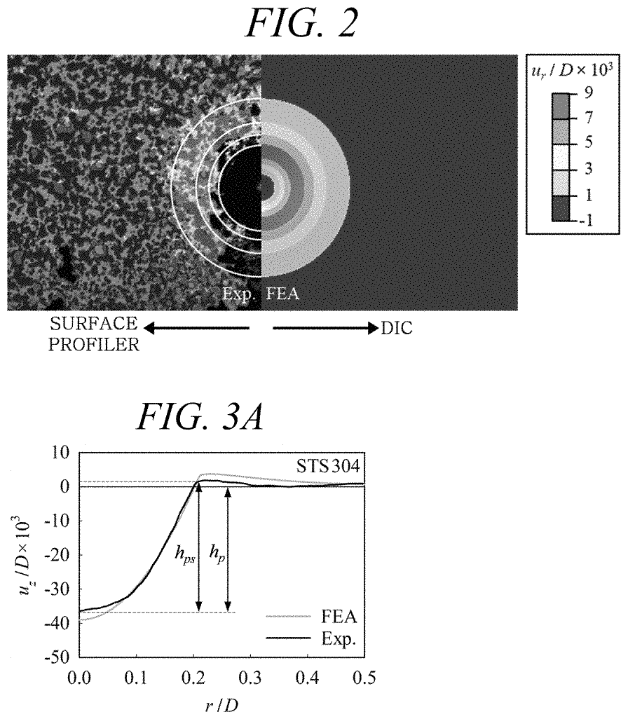

FIG. 2 is a picture obtained by capturing an image of an indentation using a surface profiler and a digital image correlation (DIC) technique according to an embodiment.

The left side in FIG. 2 illustrates a vertical distance value of the material measured using the surface profiler, and the right side in FIG. 2 illustrates a horizontal displacement field value measured by the DIC technique.

In the initial value calculating step S200, the vertical distance value according to the horizontal distance value generated due to the indentation, the maximum vertical distance value, and the horizontal displacement field value may be measured using an image as in FIG. 2.

The reference value calculating step S300 is a step of calculating the reference horizontal displacement field value using a relationship between the vertical distance value and the horizontal displacement field value.

Accurately, the reference value calculating step S300 is a step of calculating the reference horizontal displacement field value using the relationship between the vertical distance and the reference horizontal displacement field value for each yield strength and strain hardening exponent, which is the initial data (ii). That is, this is because even if the properties are not known, the reference horizontal displacement field value may be calculated if only the vertical distance value is known. Accordingly, by substituting the calculated vertical distance value in Function Equation 1, it is possible to obtain a reference horizontal displacement value corresponding thereto.

Further, a preset horizontal distance value (r) may be obtained using the obtained reference horizontal displacement field value in the reference value calculating step S300. Here, the relationship between the horizontal displacement field values according to the horizontal distance value for each friction coefficient, which is the initial data (i), is used.

That is, this is because if the reference horizontal displacement field value, which is the horizontal displacement field value applicable to a vertical axis of the graph, is known, the horizontal distance value applicable to a horizontal axis corresponding to the reference horizontal displacement field value may be known. Here, by substituting the reference horizontal displacement field value in Functional Equation 2, it is possible to obtain a horizontal distance value. In short, the vertical distance value may be calculated to calculate the reference horizontal displacement field value, and the horizontal distance value corresponding thereto may be determined using the reference horizontal displacement field value.

Here, more accurately, the horizontal distance value may be the reference horizontal distance value which is a fixed value. That is, if the reference horizontal displacement field value is known as illustrated in Graph 4, the reference horizontal distance value may be determined regardless of the properties. Therefore, the set horizontal distance used for the analysis may be set not to be less than the reference horizontal distance value and not to be greater than the 2*reference horizontal distance value.

From a result obtained by a user through the set horizontal distance, it is possible to acquire the horizontal displacement field value(s) from the horizontal distance value which is not less than the reference horizontal distance value and not greater than the 2*reference horizontal distance value.

The pre-set value setting step S400 is a step of setting pre-set values of the properties.

For example, the pre-set value may be composed of a first pre-set value and a second pre-set value. The first pre-set value may be a yield stress value and the second pre-set value may be a strain hardening exponent value.

The checking step S500 is a step of comparing the horizontal displacement field value obtained from a range of the preset horizontal distance value (horizontal distance which is not less than the reference horizontal distance value and not greater than the 2*reference horizontal distance value) using a relationship between the horizontal displacement field values according to the horizontal distance value for each property and the obtained horizontal displacement field values and checking whether the horizontal displacement field value and the obtained horizontal displacement field values are within the error range.

Here, for convenience of description, it is assumed that the error range is 0.5 when the strain hardening exponent value is set to 10 and the reference horizontal distance value is set to 0.4 (using Functional Equation 1) as in Graph 3, and the strain hardening exponent is set to 8 because the user does not know the strain hardening exponent of the material. In addition, the horizontal distance is set to 0.4.

In this case, initial data (iii), which is a relationship between the horizontal distance value and the vertical displacement field value for each strain hardening exponent and yield strength, is used. In this case, a result as in the graphs described above will be obtained.

However, the result is out of the error range when compared with the reference horizontal displacement field value in contrast with the result. If so, the result according to the input of the pre-set value is wrong, and thus the strain hardening exponent is assumed again.

When the strain hardening exponent value, which is an input pre-set value is input as 10, a result to be obtained is within the error range when compared with the reference horizontal displacement field value in contrast with the result. If so, the pre-set value is correct, and thus, it is possible to output the pre-set value.

On the other hand, one-to-one correspondence may not be made as described in the checking step S500. That is, the comparison may be made by range to range.

This is because the set horizontal distance value is determined as a range, which is the horizontal distance value not less than the reference horizontal distance value, rather than one value and not greater than the 2*reference horizontal distance value. Further, a plurality of reference horizontal displacement field values to be obtained are set.

Accordingly, when an arbitrary strain hardening exponent value, which is a pre-set value, is input as 7, the plurality of horizontal displacement field values may be compared with the reference horizontal displacement field values, the plurality of reference horizontal displacement field values having the strain hardening exponent of 7 in the horizontal distance value which is not less than the reference horizontal distance value and not greater than the 2*reference horizontal distance value, and the reference horizontal displacement field values having the strain hardening exponent value of 10 within the horizontal distance value which is not less than the reference horizontal distance value as an answer and not greater than the 2*reference horizontal distance value.

Further, in this case, if a difference between the reference horizontal displacement field value and the horizontal displacement field value compared within the range is not within the set error range (for example, 0.5), the pre-set value may be input incorrectly.

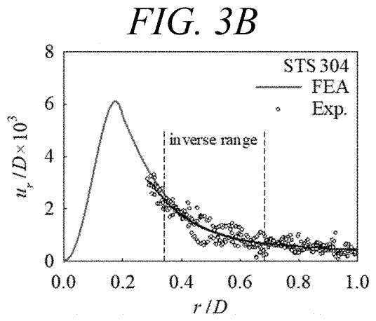

FIG. 3A illustrates the vertical distance value according to the horizontal distance and the maximum vertical distance value according to an embodiment, and FIG. 3B illustrates the horizontal displacement field value according to the horizontal distance according to an embodiment.

In addition, the indentation variable is additionally utilized in the present disclosure.

In the initial value calculating step S200 of the present disclosure, the maximum vertical distance value measured according to plastic deformation may be also calculated in addition to the vertical distance value as illustrated in FIG. 3A.

Further, in the reference value calculating step S300, a vertical indentation variable may be calculated using the calculated maximum vertical distance value and the vertical distance value.

An arbitrary yield strength value may be input as described above in the pre-set value setting step S400.

In the checking step S500, the relationship between the strain hardening exponent value and the indentation variable for yield strength and strain hardening exponent, which is the initial data (iv), may be utilized.

In the pre-set value setting step S400, an arbitrary strain coefficient value, which is the second pre-set value, is input, and when an arbitrary yield strength value, which is the first pre-set value, is input, the indentation variable corresponding thereto may be calculated. In the checking step S500, it is possible to check whether the calculated indentation variable as described above and the vertical indentation variable are within the error range (for example, 0.5) by comparing the calculated indentation variable and the vertical indentation variable.

Through the checking step S500, it is possible to check whether or not the first pre-set value is the yield strength value of the material. The present disclosure may acquire the properties of the material only using the indentation through the above steps.

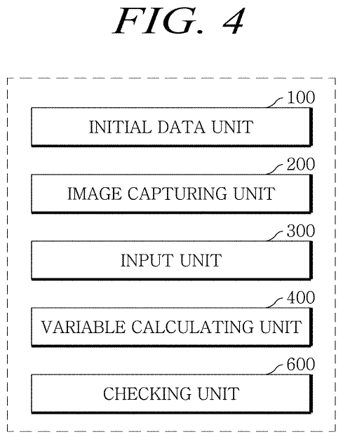

FIG. 4 illustrates a configuration of a system for obtaining properties according to an embodiment.

The system for obtaining properties according to an embodiment of the present disclosure includes an initial data unit 100, an image capturing unit 200, an input unit 300, a variable calculating unit 400, a reference value calculating unit 500, and a checking unit 600.

The initial data unit 100 stores, as initial data, the initial data (i): the relationship between the horizontal displacement field values according to the horizontal distance value for each friction coefficient, the initial data (ii): the relationship between the vertical distance value and the reference horizontal displacement field value for each yield strength and strain hardening exponent, the initial data (iii): the relationship between the horizontal distance value and the horizontal displacement field value for each strain hardening exponent and yield strength, and the initial data (iv): the relationship between the strain hardening exponent value and the indentation variable for each yield strength and strain hardening exponent.

The image capturing unit 200 may refer to a surface profiler and a plurality of cameras for the DIC technique. The image capturing unit 200 may generate first image data measured by the surface profiler and second image data measured using the plurality of cameras.

The variable calculating unit 400 serves to correspond to the initial value calculating step S200 described above.

The variable calculating unit 400 may include the first image data and the second image data.

The variable calculating unit 400 may calculate vertical distance values according to the horizontal distance value using the first image data and the maximum vertical distance value.

In addition, the horizontal displacement field values may be calculated according to the horizontal distance value using the second image data.

The reference value calculating unit 500 serves to correspond to the reference value calculating step S300.

The reference value calculating unit 500 may receive the vertical distance value from the variable calculating unit 400, and calculate the reference horizontal displacement field value corresponding to the vertical distance value by loading data about the relationship between the vertical distance value and the reference horizontal displacement field value for each yield strength and strain hardening exponent, the data being pre-stored in the initial data unit 100.

The checking unit 600 serves to correspond to the checking step S500 described above.

The checking unit 600 receives the pre-set value input by the input unit 300, and outputs and checks the horizontal displacement field value corresponding to the input pre-set value by loading the data about the relationship between the horizontal distance value and the horizontal displacement field value for each yield strength and strain hardening exponent, the data being pre-stored in the initial data unit 100.

Here, in a case where the difference between the horizontal displacement field value and the reference horizontal displacement field value is within the error range, the checking unit 600 may output an arbitrary strain hardening exponent value corresponding to the input pre-set value on the assumption that the arbitrary strain hardening exponent value is a property of the material.

Otherwise, when the difference between the horizontal displacement field value and the reference horizontal displacement field value is out of the error range, the input unit 300 may input another arbitrary strain hardening exponent value, and the checking unit 600 may perform again an operation of the above-described algorithm using the re-received strain hardening exponent value.

Further, the reference value calculating unit 500 may load the pre-stored data about the relationship between the horizontal displacement field values according to the horizontal distance value for each friction coefficient, and calculate the reference horizontal distance value corresponding to the reference horizontal displacement field value.

In addition, the horizontal distance value set as described above may be set to a range rather than a specific value. In this case, the range of the set horizontal distance value may be set not to be less than the reference horizontal distance value and not to be greater than the 2*reference horizontal distance value.

In addition, the variable calculating unit 400 may calculate the vertical indentation variable using a pre-calculated maximum vertical distance value. The vertical indentation variable is a parameter obtained by dividing the maximum vertical distance value by the vertical distance value as described above.

When the arbitrary yield strength value, which is the first pre-set value, is input to the input unit 300, the checking unit 600 calculates the strain hardening exponent value and the indentation variable corresponding to the yield strength value by loading the pre-input strain hardening exponent value and the pre-stored data about the relationship between the strain hardening exponent value and the indentation variable for each yield strength and strain hardening exponent, and checks whether the vertical indentation variable and the calculated indentation variable are within the error range by comparing the vertical indentation variable and the calculated indentation variable.

In this case, as a result of comparing the vertical indentation variable and the calculated indentation variable, when both values are within the error range, the checking unit 600 may output the first pre-set value and the second pre-set value, and otherwise, the input unit 300 may input arbitrary first pre-set value and second pre-set value.

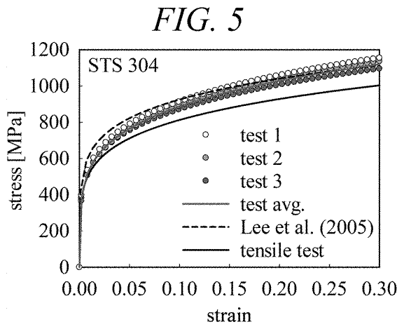

FIG. 5 illustrates, with tensile stress-strain curves, the obtaining properties in STS 304 using a tensile test, an existing indentation test method, and a method and system for obtaining properties using an indentation according to an embodiment of the present invention.

As illustrated in FIG. 5, in the present disclosure, although there is a fine difference from the existing indentation test method, a resulting value having a fine difference to some neglectable extent may be obtained.

While the present disclosure has been particularly shown and described with reference to specific embodiments thereof, it will be understood by those skilled in the art that the present disclosure may be variously modified and changed without departing from the technical idea of the present invention provided by the following claims.

### DETAILED DESCRIPTION OF MAIN ELEMENTS

S100: initial data obtaining step

S200: initial value calculating step

S300: reference value calculating step

S400: pre-set value setting step

S500: checking step

100: initial data unit

200: image capturing unit

300: input unit

400: variable calculating unit

500: reference value calculating unit

600: checking unit

What is claimed is:

1. A method for obtaining properties using an indentation, the method comprising:
an initial value calculating step of calculating a vertical distance value from the indentation;
a reference value calculating step of calculating, from a preset horizontal distance value, a reference horizontal displacement field value, which is a horizontal displacement field value corresponding to the calculated vertical distance value from the indentation, using a relationship between a pre-obtained vertical distance value and the reference horizontal displacement field value;
a pre-set value setting step of setting an arbitrary pre-set value of the properties; and
a checking step of checking whether the properties are set as the pre-set value by comparing the horizontal displacement field value obtained from the preset horizontal distance value with the reference horizontal displacement field value and checking whether the horizontal displacement field value and the reference horizontal displacement field value are within an error range, using a relationship between horizontal displacement field values according to a pre-obtained horizontal distance value for each property.

2. The method of claim 1, wherein in the reference value calculating step, the reference horizontal displacement field value and a reference horizontal distance value, which is a horizontal distance value corresponding to the reference horizontal displacement field value, are calculated using a relationship between the horizontal displacement field values according to a pre-obtained horizontal distance value for each friction coefficient, and
the pre-set horizontal distance value is set to be within a range of not being less than the reference horizontal distance value.

3. The method of claim 1, wherein in the initial value calculating step, a maximum vertical distance value measured according to plastic deform of the material is calculated, and
in the reference value calculating step, a vertical indentation variable is calculated by dividing the maximum vertical distance value by the vertical distance value.

4. The method of claim 4, wherein in the pre-set value setting step, the pre-set value includes an arbitrary set strain hardening exponent value and arbitrary yield strength value, and
in the checking step, a relationship between the strain hardening exponent value of materials having different yield strengths and indentation variables calculated by dividing the maximum vertical value by the vertical distance value is pre-obtained, and whether an indentation variable calculated according to the pre-set value and the vertical indentation variable are within the preset error range is checked by comparing the indentation variable and the vertical indentation variable.

5. The method of claim 4, wherein in the checking step, the pre-set value is reset when any one of a result of comparing the calculated horizontal displacement field value with the reference horizontal displacement field value in the reference value calculating step and a result of comparing the indentation variable and the vertical indentation variable are out of the error range.

6. A system for obtaining properties, the system comprising:
a variable calculating unit configured to calculate a vertical distance value from indentation data of a material;
a reference value calculating unit configured to receive the vertical distance value and calculate a reference horizontal displacement field value corresponding to the vertical distance value using a relationship between a pre-stored vertical distance value and the horizontal displacement field value; and
a checking unit configured to receive an arbitrary pre-set value of the properties, output a horizontal displacement field value corresponding to the pre-set value using a relationship between horizontal displacement field values according to a pre-stored horizontal distance value for each property, and check whether the output horizontal displacement field value and the reference displacement field value are within an error range by comparing the output horizontal displacement field value and the reference displacement field value.

7. The system of claim 6, wherein the reference value calculating unit calculates a reference horizontal distance value corresponding to the reference horizontal displacement field value using pre-stored data about a relationship between the horizontal displacement field values according to the horizontal distance value for each friction coefficient, and
the preset horizontal distance value is at least not less than the reference horizontal distance value.

8. The system of claim 6, wherein the variable calculating unit calculates a maximum vertical distance value measured according to plastic deform and pre-calculated through the indentation data, and
the reference value calculating unit calculates a vertical indentation variable by dividing the maximum vertical distance value by the vertical distance value.

9. The system of claim 8, wherein a strain hardening exponent of materials having different yield strengths and a relationship between indentation variables obtained by dividing the maximum vertical distance value by the vertical distance value is pre-stored, and
when the strain hardening exponent value is received as the pre-set value, the checking unit calculates a constant value corresponding to the received strain hardening exponent value and compares the constant value and a reference constant value to check whether the constant value and the reference constant value are within the error range.
